(19) United States
(12) Patent Application Publication
(10) Pub. No.: US 2018/0245489 A1
(43) Pub. Date: Aug. 30, 2018

(54) SOLENOID-ACTUATED PRESSURE-RELIEF VALVE

(71) Applicant: BorgWarner Inc., Auburn Hills, MI (US)

(72) Inventors: Christopher Thomas, Commerce, MI (US); Jeff Waterstredt, Royal Oak, MI (US)

(21) Appl. No.: 15/755,339

(22) PCT Filed: Aug. 27, 2015
(86) PCT No.: PCT/US15/47075

§ 371 Date: Feb. 26, 2018

(51) Int. Cl. F01M 1/16; F01M 1/20; F16K 17/06; F16K 17/04

(52) U.S. Cl. CPC F01M 1/16; F16K 17/046; F16K 17/065; F01M 1/20

(57) ABSTRACT

A pressure-relief valve for a lubrication system includes a housing defining a first chamber and a second chamber separated by a passageway, a biasing element disposed within the first chamber, a piston having a first piston portion disposed within the first chamber and a second piston portion disposed within the second chamber, and a first inlet in fluid communication with the first chamber. The first inlet allows a fluid to enter the first chamber and act upon the first piston portion to compress the biasing element at a first pressure level. The pressure-relief valve also includes a second inlet in fluid communication with a solenoid and the second chamber. The solenoid has a first position allowing the fluid to enter the second chamber to act upon the second piston portion, combining with the fluid acting upon the first piston portion to compress the biasing element at a second, lower pressure level.

### BACKGROUND

In the field of vehicle engine components, an oil pump is an apparatus that circulates pressurized oil between a storage location, such as an oil pan or tank, and the various components of the engine requiring lubrication. The circulation of oil both reduces friction between moving engine components and enables heat transfer between the pressurized oil and the engine components. Oil pumps are belt driven, using engine-generated power to circulate the pressurized oil. The power required to drive the oil pump can impact engine efficiency and overall fuel economy of the vehicle.

Fixed-displacement oil pumps are designed to support a full range of engine operating conditions, from cold start to idle to peak torque. As engine load increases, a fixed-displacement oil pump can use more power and generate higher oil pressure than is necessary for lubrication and heat transfer, negatively impacting engine efficiency and fuel economy. Thus, fixed-displacement oil pumps are designed with a pressure-relief valve that will open at a set pressure level, for example, six or seven bar, to vent oil back to the storage location or to the pump inlet in order to avoid overpressure of the oil and to limit the power expended by the engine to drive the oil pump. In addition to wasting power, generating oil pressures beyond this pressure level limit with the oil pump can cause damage to some engine components such as filter elements.

The pressure-relief valve in a fixed-displacement oil pump, generally comprising a biasing element and a piston acted upon by the pressurized oil to compress the biasing element to open the relief circuit, is designed to account for the oil pressure needs of extreme engine operating conditions, such as peak torque. Extreme engine operating conditions require an oil pressure level higher than is necessary for most engine operating conditions, thus the pressure-relief valve operates inefficiently by venting only at a relatively high pressure level. Variable-displacement oil pumps use hydraulic and electric controls to match oil pressure to the engine operating condition by changing displacement volume of the oil pump, for example, by modifying a vane configuration within the pump. A variable-displacement oil pump can improve engine efficiency and fuel economy of the vehicle by controlling the pressure of the oil, but the complexity of the design also imposes a much higher cost to the vehicle manufacturer than a fixed-displacement oil pump with a pressure-relief valve.

### SUMMARY

One aspect of the disclosed embodiments is a pressure-relief valve for a lubrication system. The pressure-relief valve includes a housing defining a first chamber and a second chamber separated by a passageway as well as a biasing element disposed within the first chamber. The pressure-relief valve further includes a piston having a first piston portion disposed within the first chamber and a second piston portion disposed within the second chamber as well as a first inlet in fluid communication with the first chamber. The first inlet allows a fluid to enter the first chamber to act upon the first piston portion to compress the biasing element at a first pressure level. The pressure-relief valve further includes a second inlet in fluid communication with the second chamber. The second inlet allows the fluid to enter the second chamber to act upon the second piston portion, combining with the fluid acting upon the first piston portion to compress the biasing element at a second pressure level. The pressure-relief valve further includes a solenoid in fluid communication with the second inlet, the solenoid having a first position allowing the fluid to enter the second inlet.

Another aspect of the disclosed embodiments is a pressure-relief valve. The pressure-relief valve includes a housing defining a first chamber and a second chamber separated by a passageway having a cross-sectional area smaller than a cross-sectional area of the first chamber and smaller than a cross-sectional area of the second chamber as well as a biasing element disposed within the first chamber. The pressure-relief valve further includes a piston having a first piston portion disposed within the first chamber and a second piston portion disposed within the second chamber. The first piston portion and the second piston portion are coupled by a piston rod extending between the first chamber and the second chamber through the passageway to fluidly seal the first chamber from the second chamber.

The pressure-relief valve further includes a first inlet in fluid communication with the first chamber and a fluid source, the first inlet allowing a fluid from the fluid source to enter the first chamber to act upon the first piston portion to compress the biasing element at a first pressure level. The pressure-relief valve further includes a second inlet in fluid communication with the second chamber and the fluid source. The second inlet allows the fluid from the fluid source to enter the second chamber to act upon the second piston portion, combining with the fluid acting upon the first piston portion to compress the biasing element at a second pressure level. The second pressure level is lower than the first pressure level. The pressure-relief valve further includes a solenoid in fluid communication with the second inlet, the solenoid having a first position allowing the fluid to enter the second inlet and a second position blocking the fluid from entering the second chamber through the second inlet. The pressure-relief valve further includes an outlet in fluid communication with the first chamber. The compression of the biasing element allows the fluid entering the first chamber to exit the first chamber through the outlet.

### BRIEF DESCRIPTION OF THE DRAWINGS

The description herein makes reference to the accompanying drawings, wherein like referenced numerals refer to like parts throughout several views, and wherein:

FIG. 1 is a cross-section illustration showing a pressure-relief valve for a fixed-displacement oil pump with a solenoid in a blocking position;

FIG. 2 is a cross-section illustration showing the pressure-relief valve of FIG. 1 with the solenoid in a venting position; and

FIG. 3 is a graphical comparison of work performed during an engine cycle by a fixed-displacement oil pump without solenoid control, by a fixed-displacement pump including the solenoid of FIGS. 1 and 2, and by a variable-displacement oil pump.

### DETAILED DESCRIPTION

A pressure-relief valve for a fixed-displacement pump used in a lubrication system includes venting capability at two distinct pressure levels, one generally higher pressure level associated with more extreme engine operating conditions such as peak torque, and one generally lower pressure level associated with more standard engine operating conditions such as cold start and part-load. The pressure level for pressure relief is determined by operation of a solenoid controlled according to engine design, fluid temperature, and engine load. When the solenoid is in a blocking position, only one portion of a piston is acted upon by pressurized fluid, and the pressure required to overcome the stiffness of a biasing element, such as a spring, is at a higher level. When the solenoid is in a venting position, a second portion of the piston is also acted upon by the pressurized fluid, and the pressure required to overcome the stiffness of the biasing element is at a lower level.

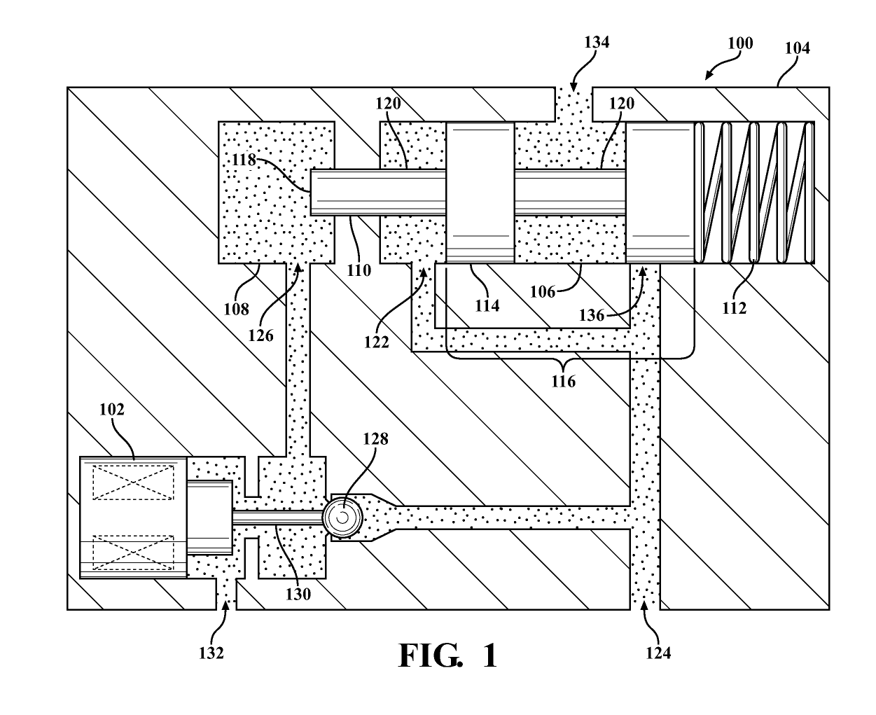

FIG. 1 is a cross-section illustration showing a pressure-relief valve 100 for a fixed-displacement oil pump (not shown) with a solenoid 102 in a blocking position, for example, where the solenoid 102 is either energized or de-energized depending on the control configuration for the solenoid 102. The pressure-relief valve 100 includes a housing 104 that defines a first chamber 106 and a second chamber 108 separated by a passageway 110 disposed between the chambers 106, 108. The pressure-relief valve 100 also includes a biasing element 112 disposed within the first chamber 106 at an end of the first chamber 106 such that compression of the biasing element 112 against the end of the first chamber 106 is possible. The biasing element 112 can be a mechanical or electromechanical device that exerts a force on an external object when extended or compressed relative to a neutral position; the biasing element 112 that is configured to return to the neutral position when force is no long applied by the external object. One example of a biasing element 112 is a spring.

The pressure-relief valve 100 also includes a piston 114 having a first piston portion 116 disposed within the first chamber 106, for example, adjacent to and configured for acting upon the biasing element 112. Translation of the piston 114 within the first chamber 106 can either compress the biasing element 112 or allow the biasing element 112 to expand, depending on the direction of translation. In the example of FIG. 1, when the piston 114 moves to the right, the biasing element 112 is compressed by the first piston portion 116. When the piston 114 moves to the left, the biasing element 112 is allowed to expand toward the first piston portion 116.

The piston 114 also includes a second piston portion 118 disposed within the second chamber 108. The second piston portion 118 can be coupled to the first piston portion 116 by, for example, a piston rod 120 extending between the second chamber 108 and the first chamber 106 through the passageway 110 in a manner that fluidly seals the second chamber 108 from the first chamber 106. The passageway 110 in this example has a cross-sectional area smaller than a cross-sectional area of the first chamber 106 and smaller than a cross-sectional area of the second chamber 108, though other configurations, such as the cross-sectional areas of the first chamber 106, passageway 110, and second chamber 108 being equal, are also possible. Further, though a piston rod 120 is described as coupling the first and second piston portions 116, 118, other means of connecting the piston portions 116, 118 through the passageway 110 are also possible.

In the example of FIG. 1, at least some portion of the first piston portion 116 has a cross-sectional area nearly equivalent to a cross-sectional area of the first chamber 106. Further, the second piston portion 118 is formed by the left-most face of the piston rod 120; thus, the piston rod 120 has a cross-sectional area smaller than a cross-sectional area of the second chamber 108. These are just examples of potential cross-sectional areas for various portions of the piston 114, and other configurations are also possible. For example, the second piston portion 118 could include a cross-sectional area nearly equivalent to the cross-sectional area of the second chamber 108. In each of the configurations described above, the first chamber 106 is fluidly sealed from the second chamber 108 by means of the piston rod 120 extending through the passageway 110.

The pressure-relief valve 100 further includes a first inlet 122 in fluid communication with the first chamber 106. The first inlet 122 allows fluid to enter the first chamber 106 and act upon the first piston portion 116. The first inlet 122 is also in fluid communication with a fluid source 124, for example, an engine gallery or an outlet of an oil pump. The pressurized fluid, such as engine oil, flows from the fluid source 124 to the first inlet 122 and acts upon the first piston portion 116. The pressurized fluid must reach a first pressure level, such as six or seven bar, in order to translate the piston 114 to the right and compress the biasing element 112. That is, fluid having a pressure reaching the first pressure level will act upon a face of the first piston portion 116 to generate a force sufficient to overcome the stiffness of the biasing element 112 and translate the piston 114 while compressing the biasing element 112.

In an engine lubrication system, this first pressure level, for example, six or seven bar, is designed to account for the oil pressure needs of extreme engine operating conditions, such as peak torque. This first pressure level is higher than is necessary for most engine operating conditions, thus the pressure-relief valve 100 can cause the oil pump to operate inefficiently by venting only once this relatively high first pressure level is achieved. The design of the pressure-relief valve 100 can be improved by including a second inlet 126 in fluid communication with the solenoid 102 and the second chamber 108. In the example of FIG. 1, the solenoid 102 is in a blocking position, with a plug 128 blocking the path of fluid from the fluid source 124 to the second inlet 126. Though a plug 128 is shown as part of a solenoid piston 130, the mechanism for closure of the pathway between the fluid source 124 and the second inlet 126 could take other forms, such as a gate, a bearing, a vane, etc. Further, though the solenoid 102 is shown as located between the fluid source 124 and the second inlet 126, the solenoid 102 can form part of the second inlet 126 or be located proximate to the fluid source 124.

When the solenoid 102 is in a blocking position, a solenoid outlet 132 can allow fluid to flow from the second inlet 126 to, for example, the engine gallery or the fluid pump outlet. The solenoid outlet 132 allows fluid located in the second chamber 108, that is, fluid that is not being actively pressurized by the fluid source 124, to return to the engine lubrication system in order to maintain filtration and control fluid temperature when the second piston portion 118 is not being used to compress the biasing element 112. The solenoid outlet 132 thus acts as a drain for the second chamber 108 when the second chamber 108 is not being used for compression purposes.

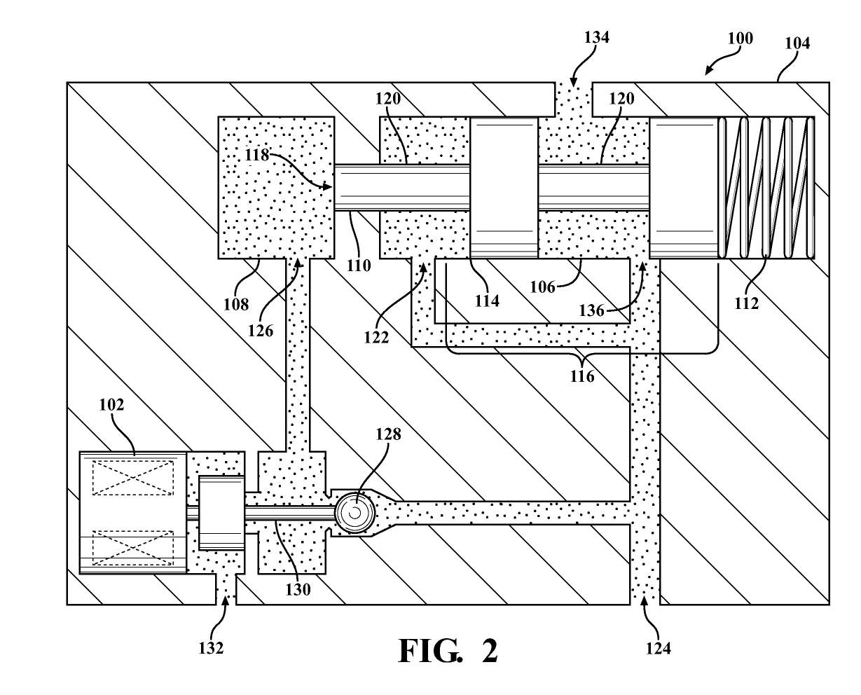

The pressure-relief valve 100 also contains an outlet 134 in fluid communication with the first chamber 106. Compression of the biasing element 112 allows fluid entering the first chamber 106 to exit the first chamber 106 through the outlet 134. In the example of FIG. 1, the outlet 134 is located between separate sections of the first piston portion 116. A third inlet 136 is located within the first chamber 106 in a position such that compression of the biasing element 112 will open the third inlet 136 and allow fluid from the fluid source 124 to enter the first chamber 106 at the third inlet 136 and exit the first chamber 106 at the outlet 134, thus venting the oil pump. Though the first piston portion 116 is shown as two sections separated by a portion of the piston rod 120, the first piston portion 116 can alternatively include a single section that blocks both the third inlet 136 and the outlet 134 until the biasing element 112 is compressed. Operation of the piston 114 is generally the same regardless of the number of piston sections on the first piston portion 116. Compression of the biasing element 112 is further described in association with FIG. 2.

FIG. 2 is a cross-section illustration showing the pressure-relief valve 100 of FIG. 1 with the solenoid 102 in a venting position, again, where the solenoid 102 is either energized or de-energized depending on the control configuration for the solenoid 102. Moving the solenoid 102 to a venting position, for example, under the direction of an engine control unit (ECU), can cause translation of the solenoid piston 130 to open the plug 128, allowing fluid to enter the second chamber 108 through the second inlet 126. The fluid can thus act upon the second piston portion 118. Since the fluid from the fluid source 124 is also acting upon the first piston portion 116 at the same time, the force needed to overcome the stiffness of the biasing element 112 with the piston 114 can be generated by a lower, second pressure level since the area being acted upon by the fluid, that is, the combination of the areas of the first piston portion 116 and the second piston portion 118, has been increased.

The second pressure level can be, for example, a value between two and four bar, such that energizing the solenoid 102 allows the pressure-relief valve 100 to vent fluid at this second pressure level. Many engine operating conditions, such as part load or part throttle, engine idle, and engine cold start require less fluid pressure to maintain lubrication of engine components during engine operation than is required for more extreme engine operating conditions such as peak torque or peak throttle. By venting fluid through the pressure-relief valve 100 at a lower pressure level during these operating conditions, less work is required from the oil pump since the oil pump is not required to drive the pressure head of the fluid. With less work required by the pump, a better overall vehicle fuel economy can be achieved. The ECU can be programmed to energize and de-energize the solenoid 102 based, for example, on engine design, fluid (oil) temperatures, and engine load.

In FIG. 2, the biasing element 112 has been compressed by the combined force generated by the fluid acting both on the first piston portion 116 and on the second piston portion 118. Once the biasing element 112 is compressed, the third inlet 136 allows fluid from the fluid source 124 to cross the first chamber 106 and exit the pressure-relief valve 100 through the outlet 134. The outlet 134 can be in fluid communication with, for example, the engine gallery or an oil pan. In one embodiment, the outlet 134 can be in fluid communication with the engine's cylinder head (part of the engine gallery), and fluid that has been heated by the oil pump can be sent to the cylinder head to assist in warming the combustion components of the engine during cold start, improving engine efficiency since as engine oil temperature increases, the energy required to pump it at cold conditions decreases.

In the example described in FIG. 2, the third inlet 136 will only remain open, and thus, fluid will only be vented through the outlet 134, for as long as the pressure level of the fluid from the fluid source 124 remains above the second pressure level when the solenoid 102 is in a venting position. Once the pressure level drops below the second pressure level, or if the solenoid 102 is in a blocking position as in FIG. 1, once the pressure level drops below the first pressure level, the piston 114 will be forced to translate back to the left by expansion of the biasing element 112 and the third inlet 136 will be closed by the first piston portion 116. Pressure can again build within the fluid source 124 based on the engine operating conditions until venting is again triggered within the pressure-relief valve 100.

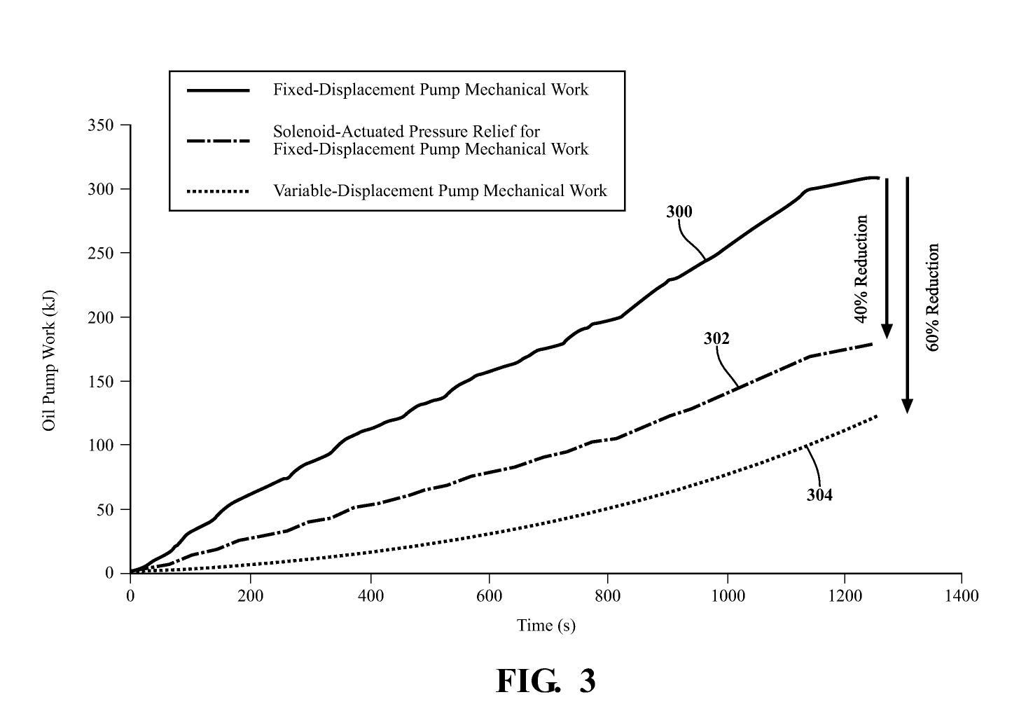

FIG. 3 is a graphical comparison of work performed during an engine cycle by a fixed-displacement oil pump without solenoid control as shown by line 300, by a fixed-displacement pump including the solenoid 102 of FIGS. 1 and 2 as shown by line 302, and by a variable-displacement oil pump as shown by line 304. The engine cycle used to generate the graph of cumulative work by the various types of oil pumps includes a variety of engine operating conditions, and is only exemplary in nature. Other engine cycles could be run using the same oil pump types to produce similar results.

The cumulative work performed by the fixed-displacement oil pump reaches over 300 kJ as shown by the line 300 by the time that the engine cycle completes. This level of work is consistent with a high pressure level setting for the pressure-relief valve, such as six or seven bar. This type of work level can occur if the pressure-relief valve 100 remains in the configuration of FIG. 1 with the solenoid 102 in the blocking position throughout the entire engine cycle.

In contrast, the cumulative work performed by an exemplary variable-displacement oil pump, an oil pump where hydraulic and/or electric controls are used to match fluid pressure to the engine operating conditions by changing displacement volume of the oil pump, reaches approximately 120 kJ as shown by the line 304 by the time that the same engine cycle completes. Though this represents a 60% reduction in work when compared to the cumulative work of a traditional fixed-displacement oil pump, the cost and complexity of the variable-displacement oil pump is prohibitive, leading vehicle manufacturers to seek a different means to improve engine efficiency through modification of the operation of the fixed-displacement oil pump.

The pressure-relief valve 100 of FIGS. 1 and 2, when operated such that the solenoid 102 is controlled to move between the venting and blocking positions by the ECU based, for example, on engine load, the design of the engine, and measured fluid temperatures, allows a fixed-displacement oil pump to lower the cumulative work from 300 kJ as shown in line 300 to approximately 180 kJ over the engine cycle as shown in line 302. This 40% reduction in cumulative work by the fixed-displacement oil pump using a solenoid-actuated pressure-relief valve 100 leads to fuel efficiency improvements at two-thirds of the level that would be obtained using a far more expensive and complex variable-displacement oil pump.

While the disclosure has been made in connection with what is presently considered to be the most practical and preferred embodiments, it should be understood that the disclosure is intended to cover various modifications and equivalent arrangements.

1. A pressure-relief valve for a lubrication system, comprising:
a housing (104) defining a first chamber (106) and a second chamber (108) separated by a passageway (110);
a biasing element (112) disposed within the first chamber (106);
a piston (114) having a first piston portion (116) disposed within the first chamber (106) and a second piston portion (118) disposed within the second chamber (108);
a first inlet (122) in fluid communication with the first chamber (106), the first inlet (122) allowing a fluid to enter the first chamber (106) to act upon the first piston portion (116) to compress the biasing element (112) at a first pressure level;
a second inlet (126) in fluid communication with the second chamber (108), the second inlet (126) allowing the fluid to enter the second chamber (108) to act upon the second piston portion 118, combining with the fluid acting upon the first piston portion (116) to compress the biasing element (112) at a second pressure level; and
a solenoid (102) in fluid communication with the second inlet (126), the solenoid (102) having a first position allowing the fluid to enter the second inlet (126).

2. The pressure-relief valve of claim 1, wherein the solenoid (102) has a second position blocking the fluid from entering the second inlet (126).

3. The pressure-relief valve of claim 1, wherein the second position of the solenoid (102) allows the fluid to exit the second chamber (108) to at least one of an engine gallery or a fluid pump outlet.

4. The pressure-relief valve of claim 1, wherein the second pressure level is lower than the first pressure level.

5. The pressure-relief valve of claim 1, wherein the first piston portion (116) and the second piston portion (118) are coupled by a piston rod (120).

6. The pressure-relief valve of claim 5, wherein the piston rod (120) extends between the first chamber (106) and the second chamber (108) through the passageway (110).

7. The pressure-relief valve of claim 6, wherein the piston rod (120) extending through the passageway (110) fluidly seals the first chamber (106) from the second chamber (108).

8. The pressure-relief valve of claim 1, wherein the first inlet (122) and the second inlet (126) are in fluid communication with a fluid source (124).

9. The pressure-relief valve of claim 8, wherein the fluid source (124) is at least one of an engine gallery or an oil pump outlet.

10. The pressure-relief valve of claim 1, further comprising:
an outlet (134) in fluid communication with the first chamber (106).

11. The pressure-relief valve of claim 10, wherein compression of the biasing element (112) allows the fluid entering the first chamber (106) to exit the first chamber (106) through the outlet (134).

12. The pressure-relief valve of claim 10, wherein the outlet (134) is in fluid communication with an engine gallery.

13. The pressure-relief valve of claim 1, wherein the passageway (110) has a cross sectional area smaller than a cross-sectional area of the first chamber (106).

14. The pressure-relief valve of claim 1, wherein the passageway (110) has a cross sectional area smaller than a cross-sectional area of the second chamber (108).

15. A pressure-relief valve, comprising:
a housing (104) defining a first chamber (106) and a second chamber (108) separated by a passageway (110) having a cross-sectional area smaller than a cross-sectional area of the first chamber (106) and smaller than a cross-sectional area of the second chamber (108);
a biasing element (112) disposed within the first chamber (106);
a piston (114) having a first piston portion (116) disposed within the first chamber (106) and a second piston portion (118) disposed within the second chamber (108), wherein the first piston portion (116) and the second piston portion (118) are coupled by a piston rod (120) extending between the first chamber (106) and the second chamber (108) through the passageway (110) to fluidly seal the first chamber (106) from the second chamber (108);
a first inlet (122) in fluid communication with the first chamber (106) and a fluid source (124), the first inlet (122) allowing a fluid from the fluid source (124) to enter the first chamber (106) to act upon the first piston portion (116) to compress the biasing element (112) at a first pressure level;
a second inlet (126) in fluid communication with the second chamber (108) and the fluid source (124), the second inlet (126) allowing the fluid from the fluid source (124) to enter the second chamber (108) to act upon the second piston portion (118), combining with the fluid acting upon the first piston portion (116) to compress the biasing element (112) at a second pressure level, wherein the second pressure level is lower than the first pressure level;
a solenoid (102) in fluid communication with the second inlet (126), the solenoid (102) having a first position allowing the fluid to enter the second inlet (126) and a second position blocking the fluid from entering the second inlet (126); and
an outlet (134) in fluid communication with the first chamber (106), wherein compression of the biasing element (112) allows the fluid entering the first chamber (106) to exit the first chamber (106) through the outlet (134).
